(19) United States
(12) Patent Application Publication
(10) Pub. No.: US 2025/0345905 A1
(43) Pub. Date: Nov. 13, 2025

(54) SEPARABLE BLIND BEARING PULLER

(71) Applicant: Steven Richard Scott, Curlew, WA (US)

(72) Inventor: Steven Richard Scott, Curlew, WA (US)

(21) Appl. No.: 18/661,942

(22) Filed: May 13, 2024

(51) Int. Cl. B25B 27/06

(52) U.S. Cl. CPC B25B 27/062

(57) ABSTRACT

A separable blind bearing puller, having a main body assembly having a collet and a drive bolt and an expansion device, which is separable from the main body assembly, where the expansion device is preferably a ball bearing.

### PRIOR ART

There are a number of applications in which a specialized tool called a blind bearing puller is necessary to install or remove blind bearings from engagement with various engine or mechanical components. A blind bearing is one which sits in a recess in which the outer surface may be inaccessible to grasp, in cases where the bearing is to be extracted or replaced. In this case, the bearing is grasped or engaged by inserting a tool into the inner opening of the bearing. The tool has members or flanges that expand once inserted in the bearing inner opening to engage the bearing and allow it to be pulled out of its recess. This is generally done by using a drive bolt having a tapering conical tip or wedge that forces the flanges apart within the inner opening of the bearing, allowing the bearing to be removed. A problem results with the prior art because there is a lot of friction created with the radial force between the drive bolt and the tip of the collet. This force diminishes the outward force needed to expand the collet and increases the force required to tighten the drive bolt. This also greatly reduces the lifespan of the tool because the tip of the drive bolt wears against the inside of the collet.

The prior art is shown in FIGS. 1-3. In FIG. 1, a bearing 1 is shown having on outer surface 2, a central aperture 3 and an inner surface 4. A prior art blind bearing puller 20 is shown having an expansion device 25 which is inserted into the central aperture 3 of the blind bearing 1. This prior art blind bearing puller 20 is shown in detail in FIGS. 2 and 3, where FIG. 3 is a cut-away view from line 3-3 in FIG. 2. Referring now to both FIGS. 2 and 3, the prior art blind bearing puller 20 includes a main body assembly 21, having a collet 22, and a drive bolt 23 and an integrally formed expansion device 25. The collet 22 is constructed with flexible fingers 24 having finger tips 26 which when expanded, will engage with the inner surface 4 of the central aperture 3 of the blind bearing 1 (see FIG. 1) to enable the blind bearing 1 to be pulled out. This expansion is accomplished by the forward movement of the drive bolt 23, as it is rotated and advanced by screw threads (not shown), to drive the integrally formed expansion device 25, which in this case, is the tapered face 28 of the drive bolt 23, which forms in apart a truncated cone shape 27. This expansion device 25 is an integrally formed part of the tapered face 28 of drive bolt 23 and is not separable from the drive bolt 23. In this prior art, the expansion device 25 is a wedge or truncated cone shape 27 that forces the flexible fingers 24 outward as the drive bolt 23 advances, after the flexible fingers tips 26 have been inserted into the central aperture 3 of the blind bearing 1.

As mentioned above, a problem results with this prior art blind bearing puller 20 because there is a lot of friction created with the radial force between the tapered face 28 of the drive bolt 23 and the flexible fingers 24 of the collet 22. This force diminishes the outward force needed to expand the flexible fingers 24 of the collet 22 and increases the force required to tighten the drive bolt 23. This also greatly reduces the lifespan of the blind bearing puller tool 20 because the tapered face 28 of the drive bolt 23 wears against the inside of the flexible fingers 24 of the collet 22.

Thus, there is a need for a blind bearing puller with a severable expansion device.

### BACKGROUND OF THE INVENTION

An advantage of the present invention is that the ball bearing is independently formed and can be easily replaced if worn or damaged.

Another advantage is that a ball bearing can rotate freely so that wear is more evenly distributed as it is free to turn, rather than being locked into one position?

A further advantage of the present invention is that the tool reduces friction created with the radial force between the drive bolt and the engagement area of the collet.

Another advantage is that reduction of friction diminishes the outward force needed to expand the flexible fingers of the collet and decreases the force required to tighten the drive bolt.

Another advantage of the present invention is that this also greatly improves the lifespan of the blind bearing puller tool.

These and other advantages of the present invention will become clear to those skilled in the art in view of the description of the best presently known mode of carrying out the invention of the preferred embodiment as described herein and as illustrated in the several figures of the drawings.

### SUMMARY OF THE INVENTION

Briefly, one preferred embodiment of the present invention is a separable blind bearing puller having an independent expansion device which uses a ball bearing as the expansion device.

### BRIEF DESCRIPTION OF DRAWINGS

The purposes and advantages of the present invention will be apparent from the following detailed description in conjunction with the appended drawings in which:

FIG. 1 shows a isometric view of a bearing of the prior art;

FIG. 2 shows a side plan view of the blind bearing puller of the prior art;

FIG. 3 shows a cut-away view of the blind bearing puller of the prior art taken from line 3-3 of FIG. 2;

FIG. 4 shows a side plan view of the present blind bearing puller; and

FIG. 5 shows cut-away view of the present blind bearing puller taken from line 5-5 of FIG. 4.

### DETAILED DESCRIPTION OF THE INVENTION

The present invention is a separable blind bearing puller with an independently separable expansion device. This will be referred to as a separable blind bearing puller 40.

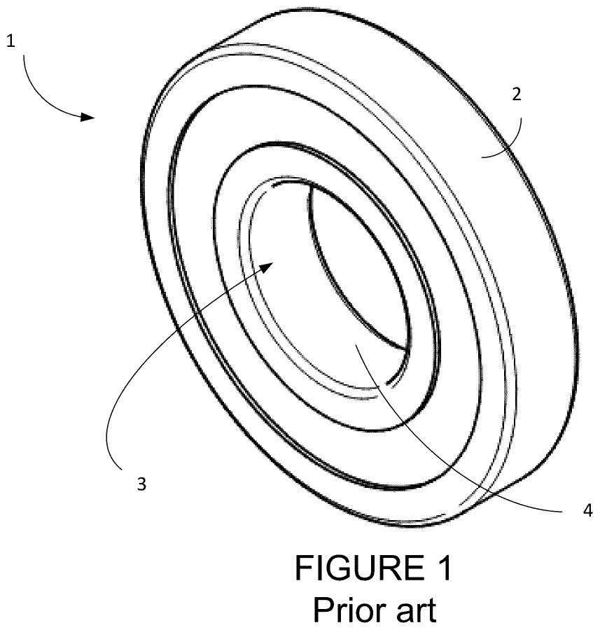

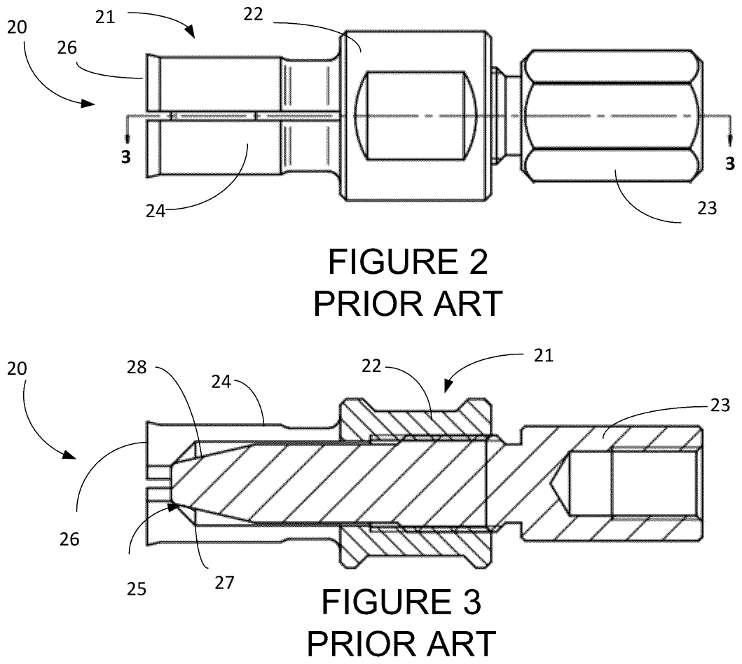

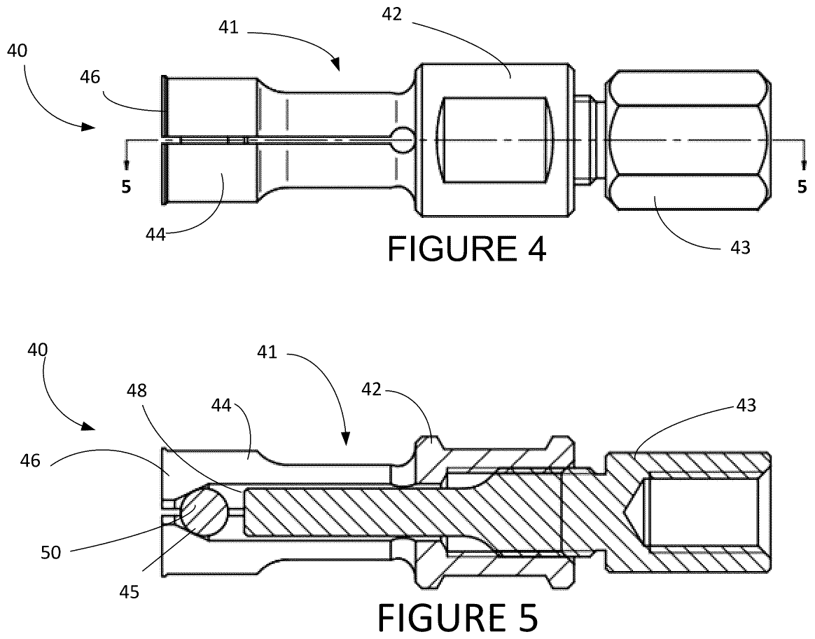

The separable blind bearing puller 40 is illustrated in FIGS. 4-5 where the separable blind bearing puller 40 is shown to have a main body assembly 41 which includes a collet 42, and a drive bolt 43. The collet 42 is constructed with flexible fingers 44 having finger tips 46 which when expanded will grip the inner surface 4 of the inner aperture 3 of the bearing 1 (see FIG. 1), to enable the bearing 1 to be pulled out. This expansion is accomplished by the forward movement of the drive bolt 43, as it is rotated and advanced by screw threads (not shown). The expansion device 45 is not formed as an integral part of the drive bolt, as in the prior art shown in FIGS. 2 and 3, and thus will be referred to as a separable expansion device 45. The drive bolt 43 has a flat face 48 to advance the separable expansion device 45 to force the flexible fingers 44 outward as the separable expansion device 45 advances as moved forward by the rotation of the drive bolt 43 after the flexible fingers 44 have been inserted into the inner aperture 3 of the blind bearing 1.

In the present embodiment, the separable expansion device 45 is a ball bearing 50, which has several advantages as described above. The ball bearing 50, being a spherical shape, is not captured, and is free to rotate when under pressure, so the expansion device 45, being the ball bearing 50, presents differing portions, so that wear is more evenly distributed and parts may last longer without wearing out or degrading performance. Also, since the ball bearing 50 is separable, and indeed removable, by extracting the drive bolt 43 from the collet 42, thus allowing the ball bearing 50 to fall out from the main body assembly 41 for easy replacement. The entire expansion device 45 ball bearing 50 then can be easily replaced by another ball bearing 50, which is easily obtainable and may be purchased as a non-specialized part.

While various embodiments have been described above, it should be understood that they have been presented by way of example only, and not limitation.

1. A separable blind bearing puller, comprising:
a main body assembly having a collet and a drive bolt; and
an expansion device, which is separable from said main body assembly.

2. The separable blind bearing puller of claim 1, wherein:
said expansion device is a ball bearing.

3. A separable blind bearing puller, comprising:
a collet having flexible fingers;
a drive bolt; and
a ball bearing, which when forced by said drive bolt expands said flexible fingers.

4. The separable blind bearing puller of claim 3, wherein:
said ball bearing is separable from said drive bolt.
